(19) United States
(12) Patent Application Publication
(10) Pub. No.: US 2018/0047283 A1
(43) Pub. Date: Feb. 15, 2018

(54) SYSTEMS AND METHODS FOR ASSIGNING RESPONSIBILITY DURING TRAFFIC INCIDENTS

(71) Applicants: Wende ZHANG, Troy, MI (US); GM GLOBAL TECHNOLOGY OPERATIONS LLC, DETORIT, MI (US)

(72) Inventors: Wende ZHANG, Troy, MI (US); Jiang DU, Beaverton, OR (US); Xiaowen DAI, Shelby Township, MI (US); Peggy Wang, Shanghai (CN)

(21) Appl. No.: 15/555,798

(22) PCT Filed: Mar. 4, 2015
(86) PCT No.: PCT/CN2015/073614

§ 371 Date: Sep. 5, 2017

(51) Int. Cl. G08G 1/01; G08G 1/056

(52) U.S. Cl. CPC G08G 1/0137; G08G 1/0112; G08G 1/0116; G08G 1/056

(57) ABSTRACT

Systems and methods analyze inputs (110,120) from one or more sources, internal or external to a vehicle, to allocate responsibility of a vehicle during a traffic incident. The system (100) includes a controller (200) for implementing a computer-readable storage device comprising a set of predetermined fault rules that cause a processor (260) of the storage device to perform operations. The system (100) analyzes the inputs (110,120), using the processor (260), according to the predetermined fault rules. In one embodiment, the system (100) includes a processor (260) and a computer-readable storage device comprising instructions that cause the processor (260) to perform operations for providing context-based assistance to a vehicle user. The operations include, in part, the system (100) parsing information received from the inputs (110,120) that can be processed to allocate responsibility among individuals operating vehicles (10,20) involved in the incident.

### TECHNICAL FIELD

The present technology relates to systems and methods for assigning responsibility amongst vehicles involved in a traffic incident. More specifically, the technology relates to assigning responsibility to involved parties using data gathered by one of the vehicles.

### BACKGROUND

When a traffic incident occurs, in some circumstances vehicle operators may not move his or her respective vehicles until authorities (e.g., police) arrive at the scene of the incident, usually for fear that the events leading to the incident will be interpreted inaccurately.

Event data recording systems, also known as black boxes, are devices used to reconstruct incident parameters. Some vehicles are equipped with original equipment manufacturer (OEM) recorders. Aftermarket black box solutions are also available.

Current black box solutions, whether factory installed or aftermarket, only capture data and do not possess the ability to analyze or interpret data captured by the data recording system.

### SUMMARY

The need exists for systems and methods to capture, upload, and process data indicative of a cause of a traffic incident to assess data potentially pertinent to an incident.

It is an objective of the present technology to receive input from one or multiple sources into a central system for interpretation or other processing. The input is processed to allocate responsibility among individuals operating vehicles involved in the incident.

While the vehicle operator of one or more of the vehicles involved in the incident is usually responsible, due to driver error, for instance, the function of assigning responsibility is in some cases described as assigning responsibility to one or more of the corresponding vehicles. In some instances, the vehicle, itself, was at fault, such as by error in vehicle functions, such as an erred performance of an automated or semi-automated function. References herein to assigning responsibility to a vehicle, including in the claims, thus incorporate scenarios in which the responsibility is with the vehicle operator or the corresponding vehicle. Also, references herein to assigning responsibility to an individual, herein, should also be broadly interpreted to disclose the same scenario whereby the vehicle, operated by an individual, is at fault.

The present disclosure relates to an incident processing system used for analyzing input data to allocate responsibility. The system includes a computer-readable storage device comprising a set of predetermined fault rules that cause a processor to perform operations for providing allocating responsibility among vehicles involved in an incident. The processor, or the processor and storage device, can constitute or be a part of a controller for this purpose.

The system receives data from one or more sources, internal or external to the vehicle(s) involved in the incident. In some embodiments, the data received may contain one or more sources of video data from one or more of the vehicles involved in the incident. In some embodiments, the video data may be received from sources external to the vehicles involved in the incident. In some embodiments, the data received may contain one or more sources of vehicle data from one or more of the vehicles involved in the incident.

The system analyzes, using the processor, the video data and/or the vehicle data according to the predetermined fault rules. In some embodiments, the fault rules are stored internal to the system. In other embodiments, the fault rules are stored external to the system such as in a repository.

In some embodiments, the system generates a preliminary report including an assessment of the incident. In some embodiments, the preliminary report contains allocated responsibility according to interpretation of the system according to the received inputs.

In some embodiments, information of the preliminary report is distributed as report data to the vehicles involved in the incident, such as through a vehicle display or individuals involved in the incident such as through a mobile device display. In some embodiments, information of the preliminary report is distributed to third parties such as law enforcement personnel or insurance companies in determining future actions, if any, that should occur in response to information provided in the preliminary report.

The present disclosure also relates to methods associated with allocating responsibility among individual involved in the incident. The method receives input data, from video and/or vehicle data from the one or more sources, processes video and interprets vehicle data using a set fault rules that are predetermined. After interpretation, allocation of responsibility, using the fault rules, is assigned to each of the vehicles involved in the incident based on interpretation of the video data and/or the vehicle data received.

In some embodiments, the fault rules determine that travel of one or more of the vehicles have a direction opposite to an intended direction of travel (e.g., vehicle is traveling in a reverse direction on a roadway intended for forward motion). In some embodiments, the fault rules determine if presence of a traffic signal at or near the scene of the incident was a factor that caused the incident to occur. In some embodiments, the fault rules determine if presence of an obstacle in a direction of travel of a vehicle was a factor that caused the incident to occur. In some embodiments, the fault rules determine if one of the vehicles departing from its specified lane of travel was a factor that caused the incident to occur.

In some embodiments, the method determines if at least one source of video data has been received into the incident processing system for analysis.

In some embodiments, the method determines if corroboration exists among multiple vehicle inputs or non-vehicle inputs sources.

In some embodiments, information of the preliminary report is distributed as report data to the vehicles involved in the incident to determine if agreement exists among the vehicle operators. Vehicle operators may agree or disagree with the responsibility allocated communicated by the preliminary report.

Other aspects of the present invention will be in part apparent and in part pointed out hereinafter.

### DESCRIPTION OF THE DRAWINGS

FIG. 1 illustrates schematically an incident processing system in accordance with an exemplary embodiment.

FIG. 2 is a block diagram of a controller of the incident processing system in FIG. 1.

FIG. 3 is a flow chart illustrating an exemplary fault sequence of the controller of FIG. 2.

FIG. 4 is schematic illustrating an exemplary scenario of a rear-end incident.

FIG. 5 is a flow chart illustrating an exemplary responsibility assignment of the schematic of FIG. 4.

FIG. 6 is schematic illustrating an exemplary scenario of a side-swipe incident.

FIG. 7 is a flow chart illustrating an exemplary responsibility assignment of the schematic of FIG. 6.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, illustrative, and similar terms, refer expansively to embodiments that serve as an illustration, specimen, model or pattern.

Descriptions are to be considered broadly, within the spirit of the description. For example, references to connections between any two parts herein are intended to encompass the two parts being connected directly or indirectly to each other. As another example, a single component described herein, such as in connection with one or more functions, is to be interpreted to cover embodiments in which more than one component is used instead to perform the function(s). And vice versa—i.e., descriptions of multiple components herein in connection with one or more functions is to be interpreted to cover embodiments in which a single component performs the function(s).

In some instances, well-known components, systems, materials or methods have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

While the present technology is described primarily in connection with a vehicle in the form of an automobile, it is contemplated that the technology can be implemented in connection with other vehicles such as, but not limited to, commercial vehicles (e.g., buses and trucks), marine craft, aircraft, and machinery.

The technology can also be implement in connection with other industries where incidents occur such as, but not limited to, construction sites, factories, and manufacturing sites. Use of the term traffic herein, thus, is not used in a limiting sense, such as to vehicular road or highway traffic, for example, but to incidents involving at least one moving object, such as a operator-controlled vehicle, a forklift, an autonomous vehicle, among others.

While the present technology is described primarily in connection with assigning responsibility for a traffic incident to one or more vehicles involved in a traffic incident, the descriptions are to be interpreted broadly to incorporate traffic incidents involving only one controlled or controllable object, such as a vehicle. The systems can determine, for example, whether a vehicle operator caused a collision between the vehicle and an inanimate object, such as a traffic sign, for instance.

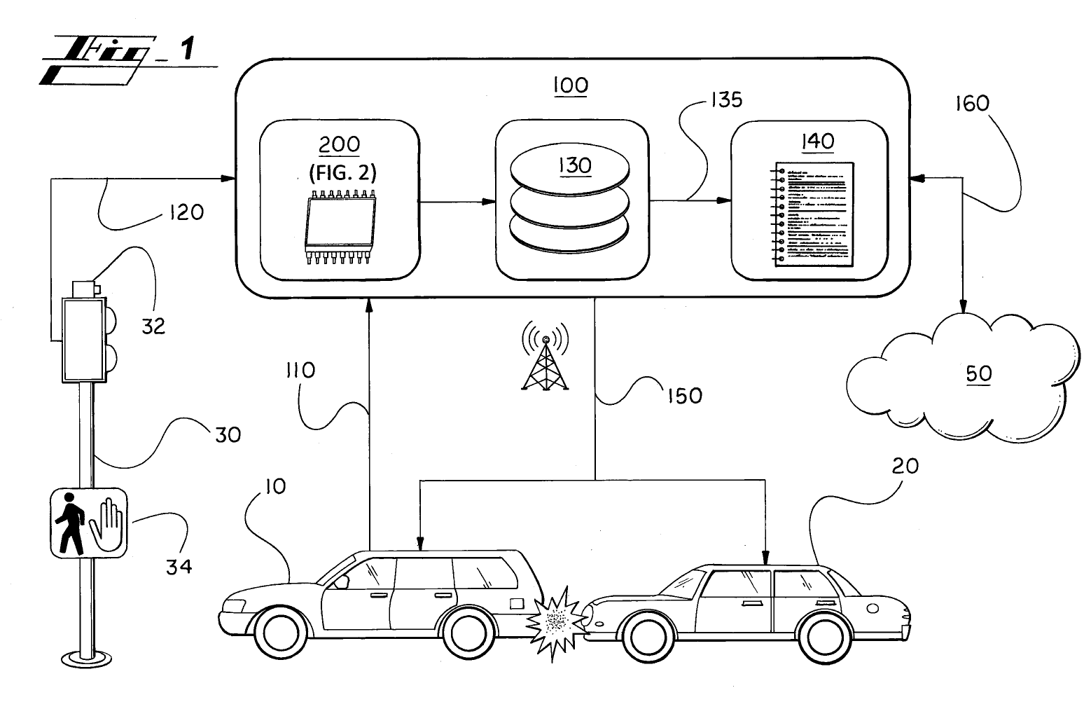

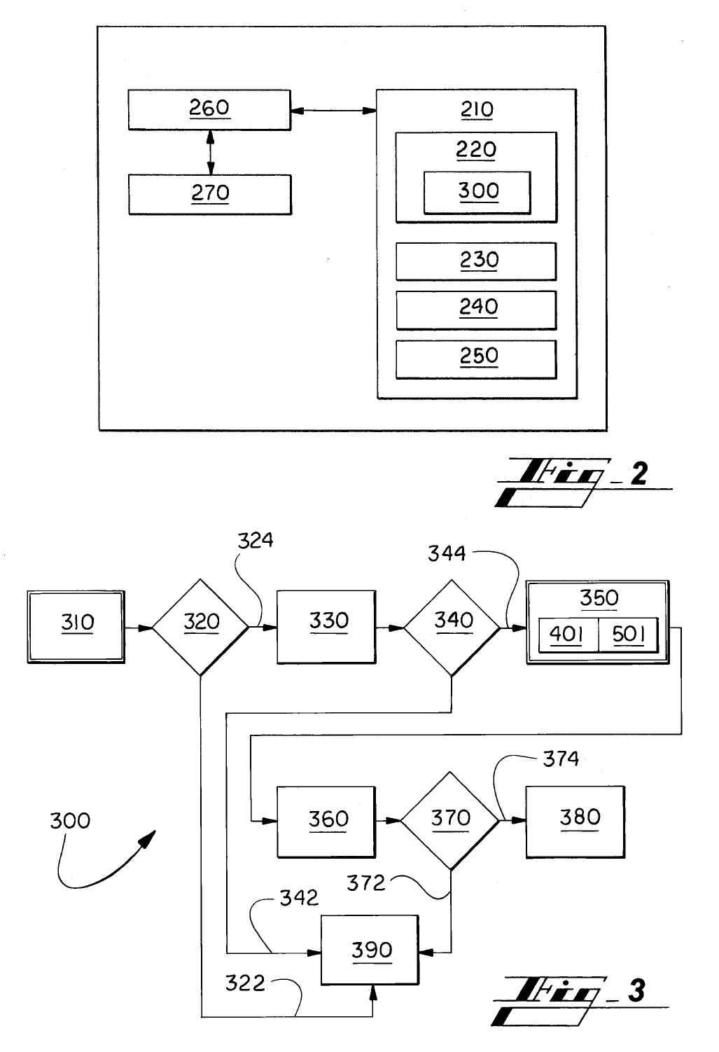

I. Overview of the Disclosure—FIGS. 1 and 2

Now turning to the figures, and more particularly to the first figure, FIG. 1 shows an incident processing system 100 including a set of fault rules 130, a controller 200, and a report 140. In some embodiments, the fault rules 130 and/or the report 140 can be constructed as part of the controller 200.

Received as inputs into the incident processing system 100 are vehicle inputs 110 as well as non-vehicle inputs 120. The inputs 110, 120 may be received into the incident processing system 100 by way of one or more input signals from, e.g., devices internal or external to the one or more vehicles involved in the incident, devices internal or external to one or more vehicles near the incident, or non-vehicle devices positioned on or within objects near the incident.

The inputs 110, 120 can be received into the system 100 as a snapshot just prior to an incident. For example, at a time just prior to the incident, information such as speed of the vehicle, position of an accelerator, and whether a breaking system was engaged may be received into the system 100.

Additionally or alternatively, the inputs 110, 120 can be received into the system 100 as a continual record of activity. For example, the average speed of vehicle or frequency of “hard braking” incidents may be recorded and communicated to the system 100 based on a predetermined passage of time (e.g., every hour).

The vehicle inputs 110 may include video data perceived by one or more cameras or other input devices that collect desirable image data internal to the vehicle and external to the vehicle. The input device(s) may be factory installed or after-market components added to the vehicle to provide additional functionality.

One or more cameras may be mounted to the front and/or rear fascia of a vehicle to perceive areas, which cannot be adequately observed by the vehicle operator while in the vehicle interior, such as an environment directly in front of or directly behind the vehicle. Additionally, one or more cameras may be mounted to the right and left portions of the vehicle to perceive objects in close proximity to the vehicle doors. For example, multiple cameras provide information from all angles surround the vehicle (e.g., 360° surrounding the vehicle). The system 100 may receive an individual input from each camera or a collective input including all data streams from a particular source (e.g., from a single vehicle).

Additionally, cameras or other input devices external to a vehicle can communicate information to the system 100 as video data within the vehicle input 110. For example, a camera affixed to a traffic signal may communicate video data to the system 100 from a period of time that is pertinent to the traffic incident.

Cameras mounted to the vehicle (e.g., rear camera) or mounted to an external object (e.g., traffic signal camera) may be communicate the video data within the vehicle input 110 to the system 100 using conventional methods of data transfer such as but not limited to cloud-based storage/transfer and Bluetooth.

The vehicle input 110 may additionally or alternatively include non-video data such, but not limited to, vehicle system data. The vehicle system data may include data perceived by sensors, actuators, or other input devices that provide information about conditions internal to the vehicle (internal conditions). Internal conditions may include information from vehicle systems and subsystems such an on board diagnostic (OBD). Internal conditions can also include readings from sensor other measuring devices mounted to interior or exterior surfaces of the vehicle. Input devices can include microphones, light-based sensors (e.g., sensors using laser), buttons, knobs, touch-sensitive displays, and/or other touch-sensitive devices. For example, an input devices may measure information such as, but not limited to, fluid level indicators (e.g., fuel, oil, brake, and transmission) and wheel speed.

The vehicle system data within the vehicle input 110 may include conditions external to the vehicle (external conditions). External conditions may include information from sources external to the vehicle such as vehicles nearby the incident and data from traffic signals at the scene the incident (e.g., to show traffic signal (color) at the time of the incident), among others. For example, devices may perceive and record information such as ambient or environmental temperatures, traffic conditions, and presence of precipitation, among others.

The non-vehicle inputs 120 can include inputs video or other data that is communicated to the system 100. For example, a traffic signal 30 (shown in FIGS. 1, 4, and 5) may include a traffic camera 32 (shown in FIG. 1) that communicates non-vehicle input 120 video data to the system 100. As another example, a building nearby the scene of the incident (not shown) may one or more cameras that communicate video data to the system 100.

The non-vehicle inputs can additionally or alternatively communicate non-video data to the system 100. For example, the traffic signal 30 may contain a crosswalk indicator 34 (shown in FIG. 1) that informs pedestrians when it is safe to cross a street. The crosswalk indicator 34 may communicate non-vehicle input 120 to the system 100 such as whether a “walk” indicator or a “don't walk” indicator was active at or near the time of an incident. As another example, a nearby building may include one or more sensors that communicate non-video data to the system 100, such as the presence of an object or person within its purview.

The non-vehicle inputs 120, in the form of video data and non-video data may be received into the system 100 by way of the controller 200 using infrastructure-to-vehicle communications, among others.

The inputs 110, 120 may be communicated to the system 100 using wireless event recorders that can also communicate the inputs 110, 120 in to a third party (e.g., an automobile dealership to assist with scheduling maintenance appointments). The inputs 110, 120 can be communicated to the system 100 using wireless technology (e.g., 4G). Based on programming and the inputs 110, 120, the system 100 assigns responsibility (e.g., fault) of the incident, as described in the methods below.

FIG. 2 illustrates the controller 200, which is an adjustable hardware. The controller 200 may be developed through the use of code libraries, static analysis tools, software, hardware, firmware, or the like.

The controller 200 includes a memory 210. The memory 210 may include several categories of software and data used in the controller 200, including, applications 220, a database 230, an operating system (OS) 240, and I/O device drivers 250.

As will be appreciated by those skilled in the art, the OS 240 may be any operating system for use with a data processing system. The I/O device drivers 250 may include various routines accessed through the OS 240 by the applications 220 to communicate with devices and certain memory components.

The applications 220 can be stored in the memory 210 and/or in a firmware (not shown in detail) as executable instructions and can be executed by a processor 260.

The processor 260 could be multiple processors, which could include distributed processors or parallel processors in a single machine or multiple machines. The processor 260 can be used in supporting a virtual processing environment. The processor 260 may be a microcontroller, microprocessor, application specific integrated circuit (ASIC), programmable logic controller (PLC), complex programmable logic device (CPLD), programmable gate array (PGA) including a Field PGA, or the like. References herein to processor executing code or instructions to perform operations, acts, tasks, functions, steps, or the like, could include the processor 260 performing the operations directly and/or facilitating, directing, or cooperating with another device or component to perform the operations.

The applications 220 include various programs, such as a fault recognizer sequence 300 (shown in FIG. 3) described below that, when executed by the processor 260, process data received by the system 100.

The applications 220 may be applied to data stored in the database 230, along with data, e.g., received via the I/O data ports 270. The database 230 represents the static and dynamic data used by the applications 220, the OS 240, the I/O device drivers 250 and other software programs that may reside in the memory 210.

While the memory 210 is illustrated as residing proximate the processor 260, it should be understood that at least a portion of the memory 210 can be a remotely accessed storage system, for example, a server on a communication network, a remote hard disk drive, a removable storage medium, combinations thereof, and the like. Thus, any of the data, applications, and/or software described above can be stored within the memory 210 and/or accessed via network connections to other data processing systems (not shown) that may include a local area network (LAN), a metropolitan area network (MAN), or a wide area network (WAN), for example.

It should be understood that FIG. 2 and the description above are intended to provide a brief, general description of a suitable environment in which the various aspects of some embodiments of the present disclosure can be implemented. While the description refers to computer-readable instructions, embodiments of the present disclosure can also be implemented in combination with other program modules and/or as a combination of hardware and software in addition to, or instead of, computer readable instructions.

The term “application,” or variants thereof, is used expansively herein to include routines, program modules, programs, components, data structures, algorithms, and the like. Applications can be implemented on various system configurations including single-processor or multiprocessor systems, minicomputers, mainframe computers, personal computers, hand-held computing devices, microprocessor-based, programmable consumer electronics, combinations thereof, and the like.

The vehicle input 110 and the non-vehicle data 120 is interpreted according to a set of predetermined fault rules 130. The fault rules 130 are software configured to interpret the inputs 110, 120 using the 260 processor.

The fault rules 130 can be used to interpret the video data received from camera(s) positioned on or within the vehicle. The fault rules 130 can also be used to interpret the video data from sources external to the vehicle, such as the traffic signal 30.

The system 100 can be used to interpret, according to the fault rules 130, the vehicle system data. In some embodiments, the system 100 may recognize, as vehicle system data, user input such as information received by one or more human-machine interfaces within the vehicle (e.g., touch screens).

The system 100 can apply the fault rules 130 to one or more sources of vehicle input 110. For example, the system 100 could use a coordinate location and/or direction of travel (e.g., from a GPS) combined with a time of day (e.g., from an in-vehicle clock display), along with the fault rules 130 to determine the fault data 135, ultimately sent to the electronic report 140.

In some embodiments, the fault rules 130 applied to the inputs 110, 120 results in a set of fault data 135 that is utilized in generating the report 140 electronically.

The report 140 communicates a set of report data 150 to one or more of the vehicles involved in the incident. The report 140 can be communicated by way of a wireless connection using requisite hardware (e.g., transceiver) or a wired connection (e.g., computer bus).

One or more output components (not shown) may communicate the report data 150 the vehicle operators. The report data 150 may be communicated visually on a device integrated into the vehicle (e.g., a display screen in center stack console) or a device a mobile device (e.g., a display screen on mobile phone or tablet) using an application. Communication of the report data 150 may be combined with auditory or tactile interfaces to provide additional information to the user. As an example, the output component may provide audio speaking from components within the vehicle (e.g., speakers).

Additionally or instead, the report data 150 may be communicated to databases or storage devices at locations such as, but not limited to insurance companies, law enforcement agencies, and automobile manufacturers.

In some embodiments, communication to the output displays can occur using near field communication (NFC). For example, where the report data 150 is displayed on screen in a center stack console of a vehicle, the report data 150 can be transmitted to a mobile device using NFC. Where an incident has occurred, NFC may be beneficial to communicate the report data 150 to interested third parties such as a law enforcement officer at the scene or dispatched to the scene of the incident, for example.

Data received into the system 100 (e.g., vehicle input 110 and non-vehicle input 120), generated by the system 100 (e.g., fault data 135), and/or produced by the system 100 (e.g., report data 150) may optionally be stored to a repository 50, e.g., a remote database, remote to the vehicle involved in the incident and/or system 100. The received data, generated data, and/or produced data may be stored to the repository 50 by way of a data signal 160.

Data stored within the repository 50 may be done so as computer-readable code by any known computer-usable medium including semiconductor, magnetic storage device (e.g., disk and tape), optical disk (e.g., CD-ROM, DVD-ROM, BLU-RAY), or the like and can be transmitted by any computer data signal embodied in a computer usable (e.g., readable) transmission medium (such as a carrier wave or any other medium including digital, optical, or analog-based medium).

Additionally, the repository 50 may be used to facilitate reuse of certified code fragments that might be applicable to a range of applications internal and external to the system 100.

In some embodiments, the repository 50 aggregates data across multiple data streams. Aggregated data can be derived from a community of users whose traffic incidents are processed using the system 100 and may be stored within the repository 50. Having a community of users allows the repository 50 to be constantly updated with the aggregated queries, which can be communicated to the controller 200. The queries stored to the repository 50 can be used, for example, to provide recommendations to automobile manufacturers based on large data logged from multiple users.

The system 100 can include one or more other devices and components within the system 100 or in support of the system 100. For example, multiple controllers may be used to recognize context and produce adjustment sequences.

II. Methods of Operation—FIGS. 3 through 7

FIG. 3 is a flow chart illustrating a fault sequence 300 executed by the controller 200. The sequence 300 represents functions performed by a processor executing software for producing the deliverables described. In some embodiments, the controller 200 performs one or more of the functions in response to a trigger, such as upon determination of existence of one or more of a predetermined set of parameters. The parameters may consider initiating the sequence 300, for example when an incident occurred.

It should be understood that the steps of the methods are not necessarily presented in any particular order and that performance of some or all the steps in an alternative order, including across these figures, is possible and is contemplated.

The steps have been presented in the demonstrated order for ease of description and illustration. Steps can be added, omitted and/or performed simultaneously without departing from the scope of the appended claims. It should also be understood that the illustrated method or sub-methods can be ended at any time.

In certain embodiments, some or all steps of this process, and/or substantially equivalent steps are performed by a processor, e.g., computer processor, executing computer-executable instructions, corresponding to one or more corresponding algorithms, and associated supporting data stored or included on a computer-readable medium, such as any of the computer-readable memories described above, including the remote server and vehicles.

The sequence 300 begins by initiating the software through the controller 200. The inputs 110, 120 may be received into the system 100 according to any of various timing protocols, such as continuously or almost continuously, or at specific time intervals (e.g., every ten seconds), for example. The inputs 110, 120 may, alternatively, be received based on a predetermined occurrence of events (e.g., at the time an incident occurs or a “near miss” occurs).

At step 310, the vehicle input 110 and/or the non-vehicle inputs 120 are received into the system 100. As discussed above, the vehicle input 110 and can be communicated to the system 100 using one or more input signals derived from one or more sources such as a vehicle involved in the incident or a traffic camera near or approximately near the incident, among others. Similarly the non-vehicle input 120 can be communicated to the system 100 using one or more input signals derived from non-vehicle objects near or approximately near the incident.

In some embodiments, at step 320, the sequence 300, using the processor 260, determines if at least one source from the inputs 110, 120 has been received into the system 100. For example, the sequence 300 may determine if video data is received from 360° around the vehicle (e.g., front camera, rear camera, side cameras).

Where no vehicle input 110 or non-vehicle input 120 is received into the system 100 (e.g., path 322), the sequence 300 may determine that a manual report, instead of the report 140 electronically generated and communicated as the report data 150, should be provided at step 390. For example, the manual report may be created by legal authorities (e.g., law enforcement) once they have arrived at the scene of the incident.

Where at least one source of vehicle input 110 and/or non-vehicle input 120 is received into the system 100 (e.g., path 324), the sequence 300 determines responsibility based on the vehicle input 110 and the non-vehicle input 120 received into the system 100.

At step 330, the system 100, processes and interprets the vehicle input 110 and non-vehicle input 120 received into the system 100. The system 100 processes the inputs 110, 120 using the controller 200. The system 100 interprets the inputs 110, 120 based on the type of data received into the system 100 such as traffic signal detection, neighboring vehicle detection, obstacle detection, and vehicle position and direction, among others.

Traffic signal detection, based on vehicle input 110, may occur for example by video data received into the system 100 capturing the image of a traffic signal (e.g., red light or stop sign) at the scene of the incident from a vehicle camera.

Traffic signal detection, based on vehicle input 110, may also occur for example by vehicle system data where the system data suggests gradual deceleration of the vehicle as if stopping at a stop sign or a red light. Gradual deceleration of the vehicle may imply a traffic signal is present and thus prompting gradual deceleration.

Traffic signal detection, based on non-vehicle input 120 may include receipt of video data directly from a traffic signal camera for example. As another example, traffic signal detection may include receipt of other data known to be derived from a traffic signal, such as data from a pedestrian crossing attached to a traffic signal.

Neighboring vehicle detection, based on vehicle input 110, may occur for example by a side-mounted camera, received into the system 100, capturing presence of a vehicle in a neighboring lane, which could be beneficial in the system allocating responsibility in a side-swipe incident. As another example, neighboring vehicle detection may occur from a camera mounted on the front fascia of a vehicle may show the distance between the vehicle and a second vehicle in front of the vehicle during a rear-end incident.

Neighboring vehicle detection, based on vehicle input 110, could also be deduced from vehicle system data. For example, the vehicle system data may indicates a vehicle has swerved just prior to an incident. Swerving may be determined, using vehicle system data, by a drastic change in steering wheel angle over a short amount of time. Swerving may imply a neighboring vehicle is present and attempted to depart from a designated lane of travel.

Neighboring vehicle detection, based on non-vehicle input 120, may occur for example by video data captured by a camera mounted to a traffic signal.

Obstacle detection, based on vehicle input 110, may occur for example from a front-mounted camera, whose data is received into the system 100, captures the presence of an obstacle in the path of vehicle travel prior to the incident. Alternatively or additionally, receipt of non-vehicle input 120 from the traffic signal camera 30 can also confirm presence of an obstacle.

Obstacle detection, based on vehicle input 110, could also be deduced for example due to the vehicle quickly decelerating (e.g., hard braking) or the vehicle suddenly changes the steering wheel position (e.g., swerving). Hard braking or swerving could indicate the vehicle operator attempting to stop short of an object in the direction of travel of the vehicle or to avoid collision with an object in the direction of travel of the vehicle.

Obstacle detection, based on non-vehicle input 120, may occur for example by video data directly from a traffic signal or nearby building camera for example which show an object is present in a path of travel. As another example, obstacle detection may include non-video data, such as data received by an infrared sensor that is affixed to a nearby building and detects movement of a person or object.

Vehicle position detection, based on vehicle input 110, may occur for example from video data from a vehicle camera (e.g., to determine positon of the vehicle in relation to other vehicles).

Vehicle position detection, based on vehicle input 110, could also be deduced for example by identifying the vehicle is moving in a forward direction (e.g., gear shift in drive position). As another example, an approximate location of the vehicle during the accident could be calculated based on an average speed of the vehicle (e.g., as recognized by the speedometer) and time of travel (e.g., as recognized by an on-board timing system). Position calculation may determine an approximate location of a vehicle during the incident, which may not have been perceived by a camera, for example.

Vehicle position, based on non-vehicle input 120, may occur for example from a camera affixed to a traffic signal or nearby building to determine the positon of the vehicle with respect to an intersection or another vehicle.

Traffic signal detection, neighboring vehicle detection, obstacle detection, and vehicle position detection deduced solely on vehicle system data within the vehicle input 110 can be corroborated by other video data or non-vehicle input 120, as discussed in association with step 340.

In some embodiments, at step 340, the sequence 300, using the processor 260, determines if corroboration exists amongst multiple data sources. For example, the sequence 300 may determine if the vehicle input 110 confirms or contradicts the interpretation of the non-vehicle input 120. Additionally or alternatively, the sequence 300 may determine if the video data within the vehicle input 110 confirm or contradict the interpretation of the vehicle system data.

Multiple data sources can include the video data and the vehicle system data from one or more vehicles (e.g., a first vehicle 10 and a second vehicle 20) can be compared and used for corroboration. For example, where the vehicle system data suggests the vehicle has swerved (e.g., as denoted by a sudden change in the steering wheel position), the video data from a vehicle camera or non-vehicle camera may show the vehicle swerved to avoid collision with an obstacle in the path of the vehicle.

If corroboration does not exists among the inputs 110, 120 (e.g., path 342), the sequence 300 may suggest creation of a manual report (e.g., by authorities) at step 390.

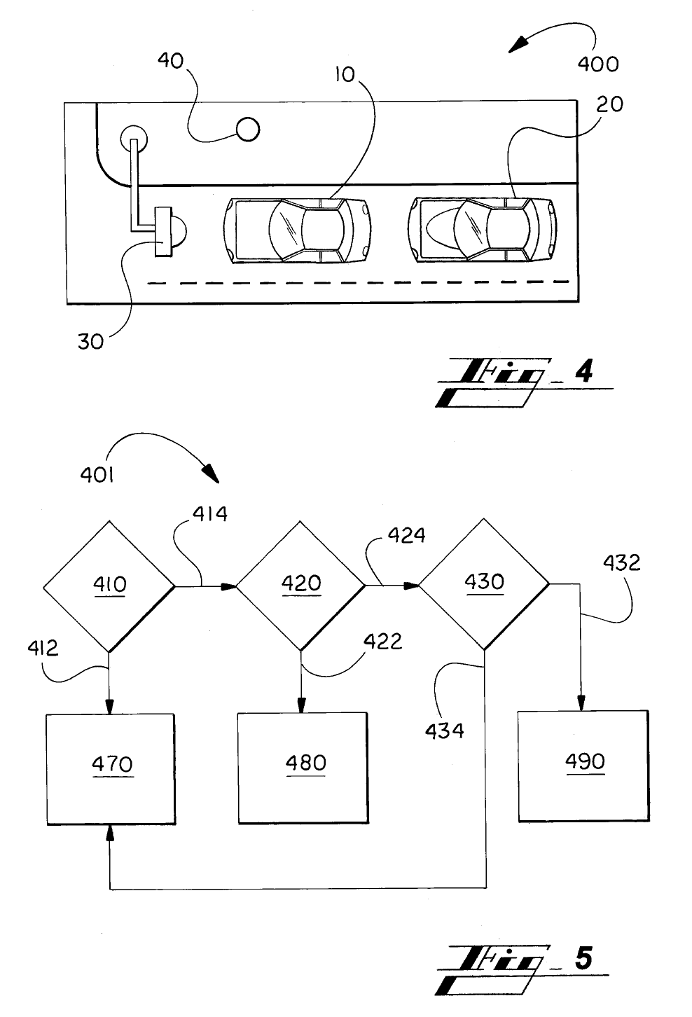

If corroboration exists among the inputs 110, 120 (e.g., path 344), the sequence 300, using the processor 260 at step 350, executes one or more subsequences, described below, which assign responsibility based on predetermined rules executed by the controller 200. The system 100 assigns responsibility based on the interpretation of the data received into the system 100 such as if a colliding vehicles are in the same lane or different lanes, described in association with FIGS. 4 through 7 described below.

FIG. 4 illustrates a scenario 400 where a first vehicle 10 and a second vehicle 20 are in the same lane. As illustrated the first vehicle 10 is positioned at the traffic signal 30, and the second vehicle 20 is positioned behind the first vehicle 10.

FIG. 5 illustrates a subsequence 401 including a set of predetermined fault rules, executed by the controller 200, to allocate responsibility for the scenario where the first vehicle 10 and the second vehicle 20 are in the same lane (illustrated in FIG. 4).

First, at step 410, the subsequence 401 determines if movement of the first vehicle 10 is opposite to the initial direction of travel of the first vehicle 10. Movement may be opposite to the direction of travel, where the first vehicle 10 travels in an initial direction and then takes action (e.g., shifts gears) to change the course of travel to a position that is opposite the initial direction. For example, where the gear shift of the first vehicle 10 is in a drive position, the initial direction of travel is forward. However, when the gear shift is changed to a reverse position, the first vehicle 10 begins to travel in reverse, which is opposite the initial direction of travel forward.

Direction of travel can be determined by the vehicle input 110 and/or the non-vehicle input 120. For example, the vehicle 10 is determined to be in reverse based on the vehicle system data that indicates the gearshift position was in reverse at the time of the incident.

Where the first vehicle 10 has motion opposite the initial direction of travel (e.g., path 412), the subsequence 401 can allocate all responsibility for the incident to the first vehicle 10 at step 470.

Where the first vehicle 10 does not move opposite the initial direction of travel (e.g., path 414), the subsequence 401 may then determine if a traffic signal (e.g., traffic signal 30) is present at step 420.

Presence of a traffic signal can be determined by the vehicle input 110 and/or the non-vehicle input 120. For example, the video data from a camera affixed to the first vehicle 10 may verify that a traffic signal 30 (e.g., stop light) is present. Additionally, the vehicle system data may suggest or confirm presence of the traffic signal 30 through an interpretation of gradual braking by the vehicle operator to bring the vehicle to a stop.

Where a traffic signal is present (e.g., path 422), the subsequence 401 can allocate all responsibility for the incident to the second vehicle 20 at step 480. For example, where the first vehicle 10 was not moving opposite the initial direction of travel and a traffic signal 30 is present, the subsequence 401, may determine that the first vehicle 10 adhered to the traffic signal 30 by slowing down and stopping, whereas the second vehicle 20 did not adhere to the traffic signal 30, causing a rear-end collision.

Where a traffic signal is not present (e.g., path 424), the subsequence 401 may determine the presence of an obstacle 40 in a path of travel of the first vehicle 10 at step 430.

Presence of the obstacle 40 can be determined by the vehicle input 110 and/or the non-vehicle input 120. For example, the video data from a camera affixed to the vehicle or external source (e.g., traffic signal 30) may verify that the obstacle 40 is present. As another example, the vehicle system data may suggest presence of the obstacle 40 through an interpretation of a sudden change in position of the steering wheel angle of the first vehicle 10, denoting swerving. The sudden change in the steering wheel angle may suggest swerving of the first vehicle 10 to avoid collision with the obstacle 40.

Where the obstacle 40 is in the path of travel of the first vehicle 10 (e.g., path 432), the subsequence 401 can allocate responsibility among the first vehicle 10 as well as the second vehicle 20 at step 490.

Split allocation of responsibility may determine that, if the first vehicle 10 was not moving opposite the initial direction of travel, a traffic signal is not present, and an obstacle was present in the path of travel of the first vehicle 10, that the first vehicle 10 and the second vehicle 20 is partially responsible for a rear-end collision. The first vehicle 10 may be determined to be responsible, for example, for a hard braking episode to avoid collision with the obstacle 40, and the second vehicle 20 may be responsible, for example, for failure to maintain enough distance behind the first vehicle 10 to avoid the rear-end collision.

Split allocation of responsibility can be quantified based on predetermined metrics such as governmental regulations, traffic regulations, and preset mathematical equations, among others. Split allocation calculations, stored within the subsequence 401 and executed by the processor 260, may be dependent on country or region of implementation of the system 100 to accommodate differing regulations, guidelines, laws, and enforcement procedures, among others.

Accordingly, the subsequence 401 may allocate specific amounts of responsibility to each vehicle 10, 20. For example, the subsequence 401 may allocated that 50% of the incident was incurred by the first vehicle 10 and the remaining 50% of the incident was incurred by the second vehicle 20.

Where the obstacle 40 is not present (e.g., path 434), the subsequence 401 can determine that responsibility should be allocated among the first vehicle 10 at step 470. The example scenario illustrated in FIG. 4 suggests responsibility may be allocated completely to the first vehicle 10 where no traffic signal is or obstacle are present in the path of travel of the first vehicle 10.

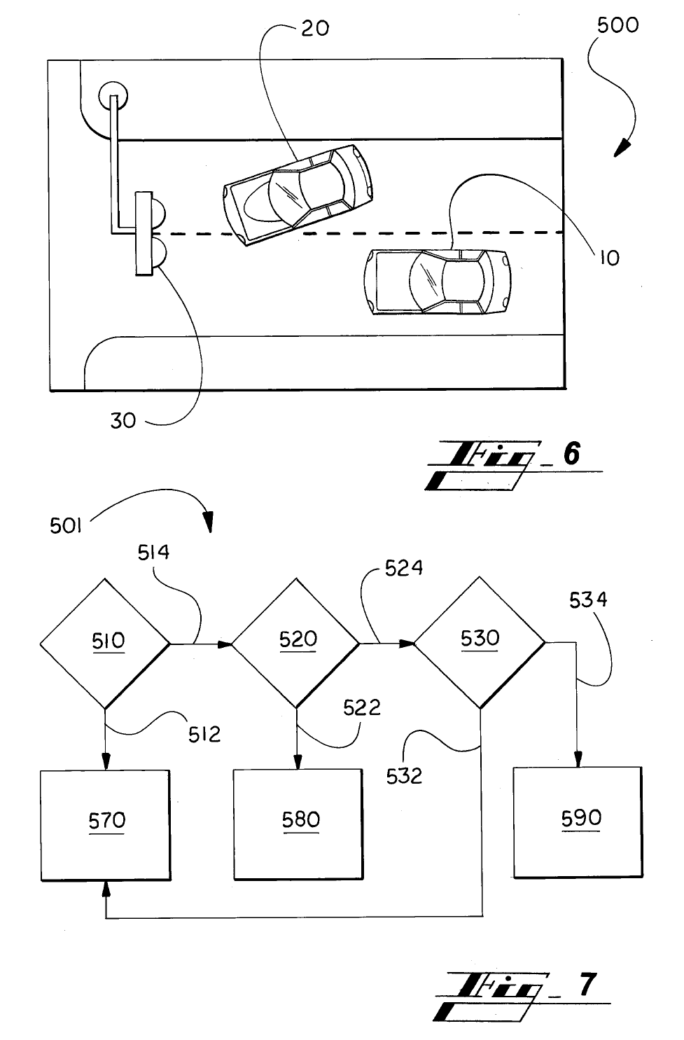

FIG. 6 illustrates a scenario 500 where the first vehicle 10 and the second vehicle 20 are in the different lanes. As illustrated, the first vehicle 10 is traveling in a left lane, the second vehicle 20 is traveling in a right lane, both vehicles 10, 20 are approaching the traffic signal 30, and the second vehicle 20 crosses into the left lane (e.g., to make a left turn at the traffic signal 30).

FIG. 7 illustrates a subsequence 501 including a set of predetermined fault rules, executed by the controller 200, to allocate responsibility for the scenario where the first vehicle 10 and the second vehicle 20 are in different lanes (illustrated in FIG. 6).

At step 510, the subsequence 501 may determine if the first vehicle 10 has motion in a direction opposite an initial direction of travel (e.g., vehicle 10 in reverse). As stated above, movement may be opposite to the direction of travel, where the first vehicle travels 10 in an initial direction and then takes action to change the course of travel to a position that is opposite the initial direction.

Where the first vehicle 10 has motion opposite the initial direction of travel (e.g., path 512), the subsequence 501 can determine responsibility be fully allocated to the first vehicle 10 at step 570.

Where the first vehicle 10 does not move opposite the initial direction of travel (e.g., path 514), the subsequence 501 may then determine if the first vehicle 10 was positioned in its designated traffic lane of travel at step 520.

Determination of whether the first vehicle 10 was in its designated traffic lane can be accomplished through vehicle input 110 or non-vehicle input 120. For example, video data from a side-mounted camera on the first vehicle 10 or a camera mounted to an external object (e.g., traffic signal) can show that first vehicle 10 was within its designated lane of travel. As another example, vehicle system data can be obtained through a boundary detection system within the first vehicle 10. The boundary system may contain radar or other components to detect surfaces such as a line used to separate lanes of travel, and determine whether the first vehicle has crossed over the line used for separation.

Where the first vehicle is determined to be in its own lane (e.g., path 522), the subsequence 501 can determine responsibility associated with the second vehicle 20 at step 580. This responsibility determination may deduces that, if the first vehicle 10 was not moving opposite the initial direction of travel and the first vehicle 10 remained in its own lane, that the second vehicle 20 was responsible. The example scenario illustrated in FIG. 6 suggests responsibility may be allocated to the second vehicle 20 since there is no backwards motion of the first vehicle 10 and the first vehicle 10 is confined to its designated lane of travel.

Where the first vehicle 10 is determined to be not to be in its designated lane of travel (e.g., path 524), the subsequence 501 may then determine if the second vehicle 20 was positioned in its designated lane of travel at step 530. Similar to the first vehicle 10, determination of whether the second vehicle 20 is confined to its own traffic lane can be accomplished through vehicle input 110 (e.g., using vehicle-mounted camera(s) or vehicle boundary detection systems) or non-vehicle input 120 (e.g., non-vehicle object camera(s)).

Where the second vehicle is within its designated lane of travel (e.g., path 532), the subsequence 501 can allocate responsibility fully to the first vehicle 10 at step 570. Where there the first vehicle 10 was not moving opposite the initial direction of travel, the first vehicle 10 is within its designated lane of travel, and the second vehicle is within its lane of travel, the subsequence 501 may determine that an incident may not have occurred “but for” actions by the first vehicle 10.

Where the second vehicle 20 is not within its designated lane of travel (e.g., path 534), the subsequence 501 can allocate responsibility among the first vehicle 10 as well as the second vehicle 20 at step 590. For example, in the scenario illustrated in FIG. 6, if both the first vehicle 10 and the second vehicle 20 were not in their respective lanes of travel, then allocation of responsibility could be split among the first vehicle 10 and the second vehicle 20.

As discussed above, responsibility can be allocated by predetermined metrics to allocate specific amounts of responsibility to each vehicle 10, 20 (e.g., 50% responsibility incurred by the first vehicle 10, 50% responsibility incurred by the second vehicle 20). Additionally, split allocation calculations, stored within the subsequence 501 and executed by the processor 260, may be dependent on country or region of implementation of the system.

Returning to FIG. 3, once responsibility has been allocated (e.g., at step 350), the sequence 300, using the processor 260, communicates the report data 150 from the report 140 to the vehicle(s) (e.g., the vehicles 10, 20) at step 360. In some embodiments, as discussed at step 380, the report data 150 may additionally or alternatively be communicated to a third party such as, but not limited to, law enforcement personnel and insurance company personnel.

As discussed in association with FIG. 1, communication of the report data 150 can occur using known technologies such as, but not limited to, NFC to display the report data 150 on an output device (e.g., screen in a center stack console) within one or more vehicles. Additionally or alternatively, the report data 150 may be displayed on a device a mobile device (e.g., mobile phone or tablet) using an application.

Next, in some embodiments, the sequence 300, using the processor 260, may determine if corroboration exists amongst multiple vehicle operators at step 370. For example, the sequence 300 may determine whether the vehicle operator of the first vehicle 10 and the vehicle operator of the second vehicle 20 agree with the allocation of responsibility contained within the report data 150.

The vehicle operators may communicate with the system 100, to determine whether they agree with the allocation of responsibility provided by the report data 150. Feedback from the vehicle operators can be input into a device configured to receive human-machine interface such as, but not limited to, the microphones, buttons, knobs, touch-sensitive displays, and/or other touch-sensitive devices. One or more of the vehicle operators involved in the incident can agree, disagree, or refrain from providing feedback to the system 100.

If corroboration does not exist received from one or more of the vehicle operators (e.g., path 372), the sequence 300 may suggests creation of a manual report (e.g., by authorities) at step 390.

If corroboration does exists among the vehicle operators (e.g., path 374), the sequence 300, using the processor 260, communicates the report data 150 from the report 140 to a third party, such as but not limited to law enforcement personnel and insurance company personnel at step 380.

As discussed above, communication of the report data 150 can occur using conventional methods of data transfer such as but not limited to cloud-based storage/transfer and Bluetooth. Display of the report data 150 may occur on an output device and/or a mobile device using an application.

The sequence 300 concludes by disengaging the software through the controller 200. The sequence 300 may conclude according to any of various timing protocols, such as assigning of responsibility at step 340, communicating the report data to the vehicle operators at step 360, and/or communicating the report data 140 to third parties at step 380, for example.

III. Select Benefits

Many benefits of the present technology are described herein above. The present section presents in summary some selected benefits of the present technology. It is to be understood that the present section highlights only a few of the many features of the technology and the following paragraphs are not meant to be limiting.

One benefit of the present technology is that the incident processing system can receive and interpret input data from one or more video sources. Receiving an interpreting vehicle input from multiple sources allows the system to capture data from a scene of an incident from different views and angles, to potentially compile a 360° perspective of the incident scene.

Another benefit of the present technology is that the incident processing system can receive and interpret vehicle data captured by the vehicle concerning vehicle systems and subsystems. Receiving and interpreting vehicle system and subsystem input prior to an incident can aid in determining the condition of the vehicle prior to and/or during an incident, such as a malfunction of a vehicle system or subsystem.

Another benefit of the present technology is that the incident processing system can generate a report, based on the video data and vehicle data, including a prognosis such as assignment of responsibility prior to the arrival of law enforcement to the scene of an incident. Generation of the report prior to the arrival of law enforcement may reduce time involved with investigating and clearing an incident scene. Reducing clearing time may additionally have advantages such as easing traffic congestion after an incident.

IV. Conclusion

Various embodiments of the present disclosure are disclosed herein. The disclosed embodiments are merely examples, which may be embodied in various and alternative forms, and combinations thereof, set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

What is claimed is:

1. A computer-readable storage device comprising instructions that, when executed by a processor, cause the processor to perform operations, associated with providing fault report data to a vehicle user involved in a traffic incident, comprising:
receiving an input data package comprising a video data component comprising video data from a video source and non-video data comprising vehicle data from a vehicle subsystem; and
determining, based on the input data package, responsibility with respect to a first vehicle and a second vehicle involved in the traffic incident using a predetermined set of rules.

2. The computer-readable storage device of claim 1 wherein the set of rules comprise interpreting the input data package using the computer-readable instructions.

3. The computer-readable storage device of claim 1 wherein the rules comprise:
determining, based on the input data package, that the first vehicle traveled in a direction opposite an initial direction of travel; and
assigning responsibility for the incident to first vehicle in response to determining that the first vehicle traveled in the direction opposite the initial direction of travel.

4. The computer-readable storage device of claim 1 wherein the determining is based on traffic-signal data from a traffic signal present at a scene of the traffic incident.

5. The computer-readable storage device of claim 1 wherein the determining is based on data concerning an obstacle present at a scene of the traffic incident.

6. The computer-readable storage device of claim 1 wherein the rules comprise:
determining, based on the input data package, that either the first vehicle or the second vehicle traveled outside of a designated lane of travel during the traffic incident; and
assigning responsibility for the incident to the vehicle that traveled outside the designated lane of travel in response to determining that the vehicle traveled outside the designated lane of travel.

7. The computer-readable storage device of claim 1 wherein the rules comprise:
determining, based on the input data package, that an obstacle existed in the direction of travel of the first vehicle; and
assigning responsibility for the incident to the first vehicle in response to determining that the obstacle existed in the direction of travel of the first vehicle.

8. The computer-readable storage device of claim 1 wherein the operations further comprise corroborating the video data component and the vehicle data component.

9. The computer-readable storage device of claim 1 wherein the determining comprises assigning approximately the same amount of responsibility to the first vehicle and the second vehicle.

10. The computer-readable storage device of claim 1 wherein the determining comprises assigning a different amount of responsibility to the first vehicle and the second vehicle.

11. The computer-readable storage device of claim 1 wherein the determining comprises assigning a first amount of responsibility to the first vehicle and a second amount of responsibility to the second vehicle, wherein the first amount of responsibility is greater than the second amount of responsibility.

12. The computer-readable storage device of claim 1 wherein the operations further comprise generating, a report data set, regarding the incident, to send to the first vehicle.

13. The computer-readable storage device of claim 1 wherein the operations further comprise generating, a report data set, regarding the incident, to send to a device external to the first vehicle and the second vehicle.

14. An apparatus, comprising:
a processor; and
a computer-readable storage device including instructions that, when executed by the processor, cause the processor to perform operations, for providing a context-based output feature to a vehicle user, comprising:
receiving an input data package comprising a video data component comprising video data from a video source and non-video data comprising vehicle data from a vehicle subsystem; and
determining, based on the input data package, responsibility with respect to a first vehicle and a second vehicle involved in the traffic incident using a predetermined set of rules.

15. The apparatus of claim 14 wherein the set of rules comprise interpreting the input data package using the computer-readable instructions.

16. The apparatus of claim 14 wherein the operations further comprise corroborating the video data component and the vehicle data component.

17. The apparatus of claim 14 wherein the determining comprises assigning approximately the same amount of responsibility to the first vehicle and the second vehicle.

18. The apparatus of claim 14 wherein the determining comprises assigning a different amount of responsibility to the first vehicle and the second vehicle.

19. An method, comprising:
receiving an input data package comprising a video data component comprising video data from a video source and non-video data comprising vehicle data from a vehicle subsystem; and
determining, based on the input data package, responsibility with respect to a first vehicle and a second vehicle involved in the traffic incident using a predetermined set of rules.

20. The method of claim 19 wherein the set of rules comprise interpreting the input data package using instructions of a computer-readable device.
